(19) United States
(12) Patent Application Publication
(10) Pub. No.: US 2014/0337462 A1
(43) Pub. Date: Nov. 13, 2014

(54) Delivering Identity Related Data

(71) Applicant: Robert Skog, Hasselby (SE)

(72) Inventor: Robert Skog, Hasselby (SE)

(73) Assignee: Telefonaktiebolaget L M Ericsson (publ), Stockholm (SE)

(21) Appl. No.: 14/372,870

(22) PCT Filed: Jan. 26, 2012
(86) PCT No.: PCT/SE2012/050079

§ 371 Date: Jul. 17, 2014

(51) Int. Cl. H04L 29/08; H04L 29/12; G06F 15/173

(52) U.S. Cl. CPC H04L 67/1097; G06F 15/17331; H04L 61/6054; H04L 61/1588
USPC 709/213

(57) ABSTRACT

Method and apparatus for delivering from a storage node to an end device, a subset of data stored in the storage node and relates to an identity that uniquely identifies the identity module comprised in the end device. The storage node receives from the end device a request for the subset of the data, the request comprises the identity. The storage node identifies the data related to the identity and filters the identified data to obtain the requested subset of the data. The storage node further sends the subset of the data to the end device.

### TECHNICAL FIELD

The present invention relates to a method in a storage node for delivering a subset of data to an end device, a method in an end device for receiving from a storage node a subset of data. The invention also relates to a storage node and to an end device.

### BACKGROUND

Today, mobile operators are able to gather large amount of data typically related to end devices, e.g. to a user terminal or to a machine to machine equipment, M2ME.

The machine to machine equipment, M2ME, refers to technologies where devices are able to measure or collect data and to provide such information to another node in a communication network. Examples of the use of M2M communication include sensor networks, e.g. networks for monitoring weather conditions or for surveillance, such as e.g. an alarm system a video monitoring system, or a vehicle fleet management system.

Using data mining techniques, mobile operators can extract knowledge from the gathered data and use this knowledge to e.g. increase revenue by providing context aware and customized services to these end devices.

Mobile operators collect data records involving e.g. voice calls, messages, downloading, web browsing, e-mails, etc. This data may include information such as type of service, duration, data amount, time of day and location, successful or failed, etc. Such information is used e.g. for billing purposes and for analyzing the end user, e.g. to find out if the average revenue per user, ARPU, increases or decreases etc.

FIG. 1 is an exemplary conventional scenario for illustrating how an operator stores data records related to the end devices. In this scenario, an end device 10, a network node 12, a storage node 14 and an operator domain 16 is shown. According to the signaling diagram, the following steps occur:

Signal S1: In S1, the end device 10 informs the network node 12 about its activities.

According to another exemplary conventional scenario, not shown in FIG. 1, other communication nodes, such as e.g. a Call Detail Records (CDR) node, a Charging data Reporting System (CRS), a Multimedia Messaging Service (MMSC), a Mobile Switching centre (MSC), a Gateway GPRS support node (GGSN), a Serving GPRS Support Node (SGSN), a Proxy Node, or a Radio Network Controller (RNC), or the like, have information about activities performed by the end device 10, e.g. traffic data generated by the end device. These nodes may send such information directly to the storage node 14.

According to yet another exemplary conventional scenario, not shown in FIG. 1, the network node 12 is one of the above-mentioned CRD, CRS, MMSC, MSC, GGSN, SGSN, Proxy Node, RNC or the like. In such scenario, the network node 12 has information about activities related to the end user. As an example, if the network node 12 is a CRS node, it has information about billing information related to the end user and is able to forward this information to the storage node. Further, if the network node is an MMSC node, it has information about the MMS sent by the end user and may forward such information to the storage node 14.

Signal S2: in S2, the network node 12, in the operator domain 16, forwards the received information to the storage node 14. The network node 12 also sends the Mobile Subscriber Integrated Services Digital Network Number (MSISDN) and/or the International Mobile Subscriber Identity (IMSI) stored in the identity module of the end device 10 to the storage node 14, in order to tie the data to the end device. The storage node 14 stores this information, which can be used for e.g. data mining, or billing purposes.

Presently, user related data stored in the storage node is only available to the operator, not to the end user. However, it may be desirable for the end user to obtain information related to activities in connection with the usage of the end devices, in a secure way.

### SUMMARY

It is an object of the embodiments described hereinafter to address at least some of the issues outlined above, and this object and others are achieved by the method and the arrangement according to the appended independent claims, and by the embodiments according to the dependent claims.

According to a first exemplary aspect, embodiments provide a method in a storage node of a communication network for delivering to an end device, a subset of data, the data being stored in the storage node and related to an identity that uniquely identifies an identity module comprised in the end device. The method comprises receiving from the end device a request for the subset of the data, the request comprises the identity. The method further comprising identifying the data related to the identity and filtering the identified data to obtain the requested subset of the data. Next, the storage node sends the subset of the data to the end device.

According to a second exemplary aspect, embodiments provide a storage node connectable to a communication network and arranged to deliver to an end device, a subset of data, the data being stored in the storage node and related to an identity that uniquely identifies an identity module comprised in the end device. The storage node comprising, a receiving circuitry configured to receive from the end device a request for the subset of the data, the request comprises the identity. The storage node further comprises a processor circuitry configured to identify the data related to the identity and to filter the identified data to obtain the requested subset of the data. Next a transmitting circuitry in the storage node is configured to send the subset of the data to the end device.

According to a third exemplary aspect, embodiments provide a method in an end device of a communication network for receiving from a storage node, a subset of data, the data being related to an identity that uniquely identifies an identity module comprised in the end device. The method comprises sending via a network node to the storage node the data, the data being related to activities performed by the end device and comprises the identity. The method further comprises the end device sending a request to the storage node requesting the subset of the data, the request comprises the identity. Next the method comprises the end device receiving the subset of the data.

According to a fourth exemplary aspect, embodiments provides an end device connectable to a communication network and arranged to receive from a storage node, a subset of data, the data being related to an identity that uniquely identifies an identity module comprised in the end device. The end device comprising a transmitting circuitry configured to send via a network node to the storage node the data, the data being related to activities performed by the end device and comprises the identity. Next the end device sends a request to the storage node requesting the subset of the data, the request comprises the identity.

### BRIEF DESCRIPTION OF THE DRAWINGS

Exemplary embodiments of the invention will now be described in more detail, and with reference to the accompanying drawings, in which:

FIG. 1 schematically illustrates a first conventional exemplary signaling diagram that shows data records that relates to an end user and being stored at the operator.

FIG. 2 schematically illustrates an exemplary signaling diagram for providing a mechanism for sending to an end user, a subset of data.

FIG. 3 is a flow diagram illustrating an exemplary embodiment of a method in a storage node for sending a subset of data to an end user.

FIG. 4 is a flow diagram illustrating an exemplary embodiment of a method in an end device for receiving a subset of data from a storage node.

FIG. 5a is a schematic diagram showing some components of a storage node.

FIG. 5b is a schematic diagram showing functional modules of the storage node of FIG. 5a.

FIG. 6a is a schematic diagram showing some components of an end device.

FIG. 6b is a schematic diagram showing functional modules of the end device of FIG. 6a.

FIG. 7 shows one exemplary computer program product comprising computer readable means for performing a method in a storage node and a method in an end device.

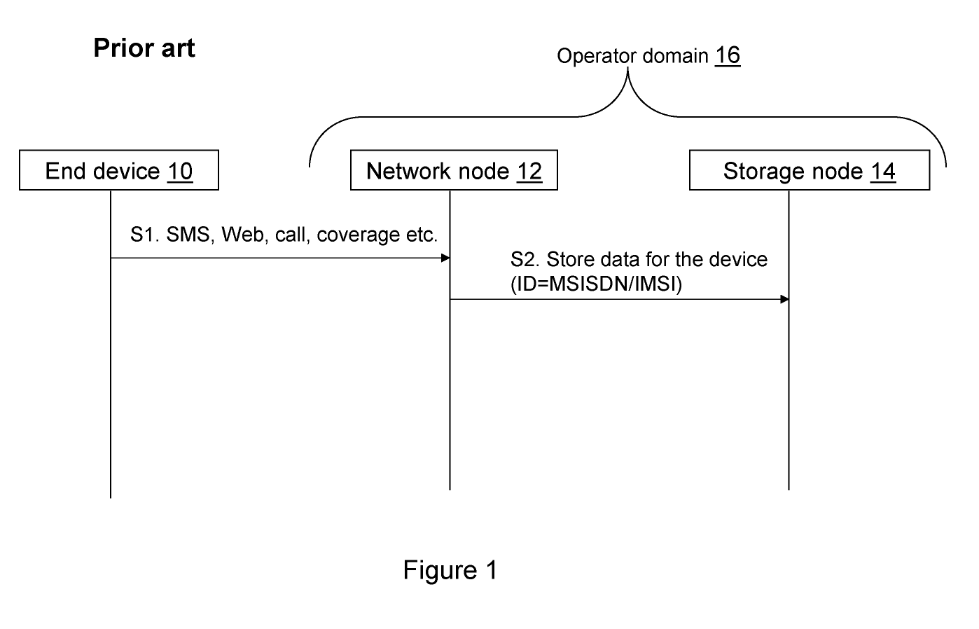

### DETAILED DESCRIPTION

In the following description, the invention will be described in more detail with reference to certain embodiments and to accompanying drawings. For purposes of explanation and not limitation, specific details are set forth, such as particular scenarios, techniques, etc., in order to provide a thorough understanding of the present invention. However, it is apparent to one skilled in the art that the present invention may be practiced in other embodiments that depart from these specific details.

Moreover, those skilled in the art will appreciate that the functions and means explained herein below may be implemented using software functioning in conjunction with a programmed microprocessor or general purpose computer, and/or using an application specific integrated circuit (ASIC). It will also be appreciated that while the current invention is primarily described in the form of methods and devices, the invention may also be embodied in a computer program product as well as in a system comprising a computer processor and a memory coupled to the processor, wherein the memory is encoded with one or more programs that may perform the functions disclosed herein.

According to exemplary embodiments described hereinafter, a subset of data stored in a storage node is identified using an identity. The subset of the data is sent to an end device provided with an identity module, wherein the identity uniquely identifies the identity module.

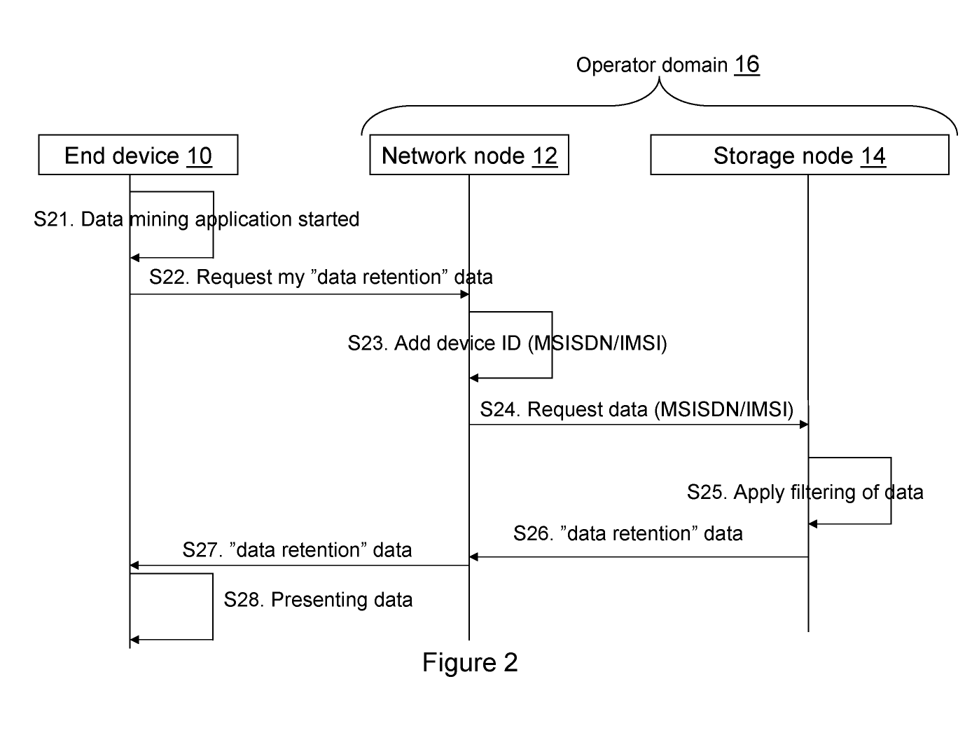

FIG. 2 schematically illustrates an exemplary signaling diagram for sending a subset of data to an end device in a communication network. In this exemplary scenario, an end device 10, a network node 12, a storage node 14 and an operator domain 16 is shown, and the end device is provided with a data mining application.

The end device is e.g. a mobile phone, a laptop or an M2ME. An M2ME device could e.g. be any device that captures an event such as a sensor mounted in a refrigerator for capturing the temperature of the refrigerator or for monitoring items in the refrigerator that needs to be restocked. The M2M device could also be a sensor for monitoring systems such as e.g. a utility meter or a sensor in a vehicle for e.g. allowing the owner to monitor the behaviour of the vehicle or to assist the owner to locate charging stations, etc.

According to the signaling diagram, the following steps occur:

Signals S21: In S21, the data mining application is started in the end device. If the end device is a user equipment, the application is started by the end user, but if the end device is an M2ME device, the application may always be up and running, or it may be started by an end user.

The purpose for using a data mining application is to allow the end user or the end device to send requests for specific data towards the storage node 14. Example of specific data is data that relates to activities performed by the end device of the end user.

According to signal S21 described above, the end device or the end user uses a data mining application when sending requests for specific data. However, other suitable applications or programs, e.g. a browser can be used to send such requests.

The storage node collects information that relates to activities performed by the end device or the end user, and is therefore able to process and provide answers to the requests.

As mentioned above, the storage node 14 may collect such information from several sources in the communication network, such as the end device itself, a CRD, a CRS, a MMSC, a MSC, a GGSN a SGSN a Proxy Node or a RNC or the like.

Example of requests sent by a data mining application may include a request for names of people that the end user have been calling, or for web sites visited by the end user.

The storage node 14 may have received such information from several nodes in the communication network wherein each one of these nodes is responsible for at least one activity performed by the end device.

As an example, information about whom the end user has been calling may have been forwarded from e.g. a Call Detail Records (CDR) node to the storage node 14.

Further, if the requested data is missing, the storage node 14 may be able to contact an appropriate node in the communication network to collect this data. For instance, if the requested data relates to web sites visited by the end user, the storage node may contact an appropriate node, e.g. a CDR node, in the communication network holding such information.

Another example of such a request may be a request from an M2ME device, such as e.g. a sensor in a refrigerator requesting the amount of milk packets ordered the latest month. According to an exemplary embodiment, the M2ME device is configured to automatically send such a request, and according to another exemplary embodiment, the end user sends such a request on behalf of the M2ME device, e.g. by using a display connected to the M2ME device. In this example the M2ME device communicates with the communication network using an identity module, e.g. a Machine Communication Identity Module (MCIM).

Another example could be a request from an end user travelling e.g. on a train or a sub way. During the duration of a trip, the end user uses an end device, e.g. a mobile phone, a lap top or the like to browse the web, and communicates with the communication network using an identity module, e.g. a SIM card.

If the end user experiences that the network coverage is not optimal during the whole trip, he may want to take some action, e.g. by reporting such issue to the operator or maybe by changing the current operator.

Consequently, the end user may use e.g. a data mining application comprised in the end device to send a request towards the storage node 14 to find out where in the route of the trip the bad coverage occurs.

The storage node 14 may have knowledge about such information, e.g. the storage node may have collected such data from an appropriate node in the communication network, such as an RNC. The RNC may have logged records that includes coordinates that geographically describes where the end device losses connection.

In yet another example, an end user is driving an electrical vehicle between two points, e.g. between home and work, and may use the data mining application comprised in the end device to find out the location of the external power stations that he/she drives through while driving from e.g. home to work. In this example, the data mining application may send a request to the storage node 14 for obtaining the coordinates describing the path that the end user drives through from home to work or vice verse. Thereafter a mapping needs to be done between the obtained coordinates and the well known coordinates that corresponds to the power stations.

Signal S22: In S22, the end device or the end user may send a request, as exemplified above, to the network node 12, requesting a subset of data related to an identity that uniquely identifies the identity module comprised in the end device. The request is preferably an HTTP request, but can be in any other suitable format.

Signal S23: In S23, the network node 12 is aware of the identity, e.g. the IMSI or the MSISDN that uniquely identifies the identity module comprised in the end device and adds it to the received request.

As an example, the end user sends a request to find out the amount of SMS that he or she has been sending the latest month. Consequently the end user uses the data mining application comprised in the end device to send such a request to the network node 12. The network node 12 receives the request and adds the identity to it.

The added identity uniquely identifies the identity module, e.g. the SIM card, comprised in the end device. The added identity is further referring to the IMSI or the MSISDN or both of them. The IMSI is stored in the identity module comprised in the end device and the MSISDN that relates to the IMSI can be obtained from any proper node in the network, e.g. a Home Location Register node, HLR node. Once the network node 12 receives a request for a sub set of data from the end device 10, it may add the IMSI or the MSISDN to the request prior sending it to the storage node 14. The network node may also add both the IMSI and the MSISDN to the request before sending it to the storage node 14.

It is worth mentioning that the request sent by the data mining application relates to the identity module and not to the end device itself. Thus the end user is able to request data related to the identity module using any end device.

Signal S24: In S24, the network node 12 forwards the request to the storage node 14.

Signal S25: in S25, the storage node 14 receives the request and identifies the data that relates to the received identity. Once the data is identified, the storage node 14 filters the data to obtain a relevant subset according to the received request.

Signal S26: in S26 the storage node 14 sends the subset of the data to the network node 12.

According to another exemplary embodiment, not shown in FIG. 2, the storage node 14 sends the subset of the data directly to the end device 10.

Signal S27: in S27 the network node forwards the subset of the data to the end device 10.

Signal S28: In S28 the data is presented to the end user in a suitable format, e.g. on a display or the like.

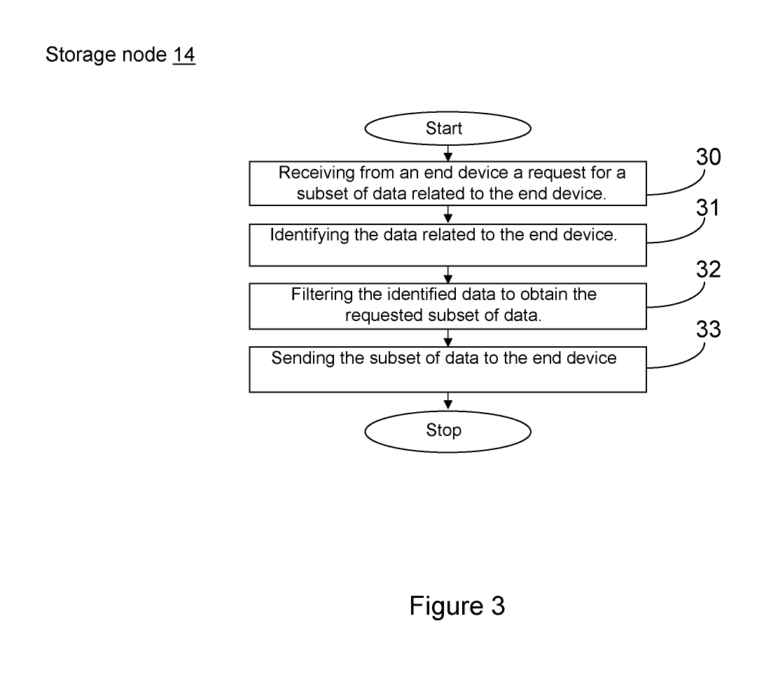

FIG. 3 is a first flow diagram illustrating an exemplary embodiment of a method in a storage node 14, for delivering to an end device 10 a subset of data relating to an identity module comprised in the end device 10.

In step 30, the storage node 14 receives from an end device 10 a request for a subset of data related to the end device. The request comprises an identity that uniquely identifies the identity module comprised in the end device.

According to another embodiment,(not illustrated in FIG. 3) the request for a subset of data is preceded by the storage node 14 receiving the data from a network node 12, wherein the data comprises the identity. The storage node 12 further stores the received data.

In step 31, the storage node 12 identifies the data that relates to the received identity.

In step 32, the storage node 12 filters the identified data to obtain the requested subset of the data.

In step 33, the storage node 12 sends the subset of the data to the end device 10.

According to another embodiment, the storage node 12 sends the subset of data to the end device 10 via the network node 12.

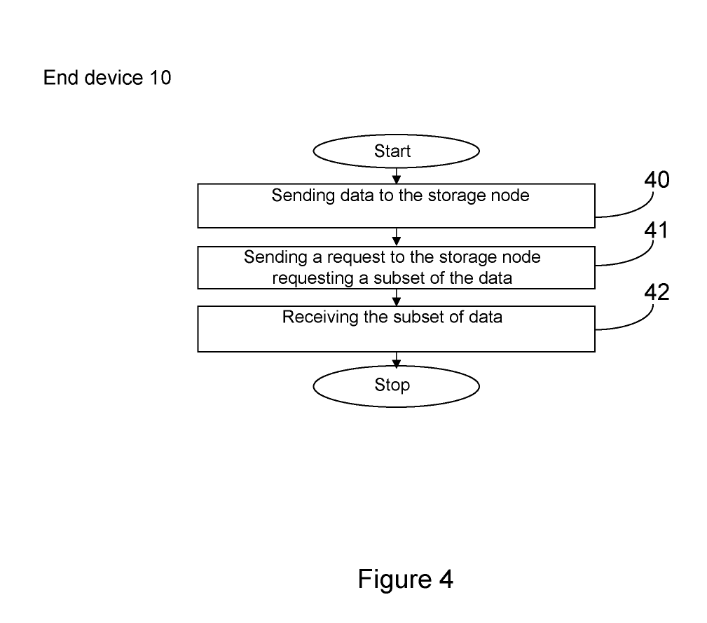

FIG. 4 is a second flow diagram illustrating an exemplary embodiment of a method in an end device 10 for receiving from a storage node 14 a subset of data. The data is related to an identity that uniquely identifies the identity module comprised in the end device 10.

In step 40 the end device 10 sends data to the storage node, via a network node 12. The data relates to activities performed by the end device 10.

In step 41, the end device sends a request to the storage node 14 requesting a subset of the data previously sent.

In step 42, the end device 10 receives from the storage node 14 the subset of the requested data.

According to another embodiment, the end device receives the subset of the data from the storage node via the network node 12.

According to another embodiment, the identity module comprised in the end device is one of a Subscriber Identity Module (SIM), a soft SIM, a Enhanced SIM (E-SIM),a Universal SIM (USIM) or a Machine Card identity Module (MCIM).

According to yet another embodiment, the identity related to the identity module is one of a Mobile Station International Subscriber Directory Number (MSISDN) or a International Mobile Subscriber Identity (IMSI) of the end device.

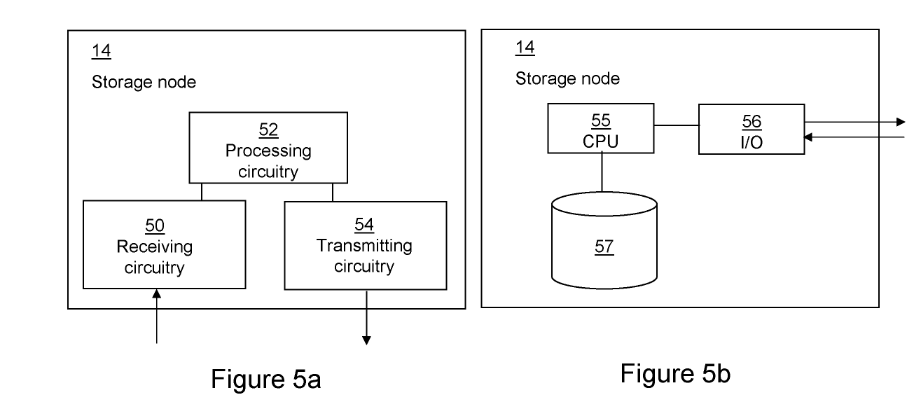

FIG. 5a is a schematic diagram illustrating functional modules of the storage node 14. The modules can be implemented using hardware and/or software such as computer program executing in the storage node 14. All modules depend on an execution environment which utilizes the components shown in FIG. 5b. The modules correspond to the steps of the method illustrated in FIG. 3.

FIG. 5a shows a receiving circuitry 50 configured to receive from an end device 10 a request for a subset of data, the request comprises an identity.

FIG. 5a also shows a processing circuitry 52 configured to identify the data that relates to the received identity and to filter the identified data to obtain the requested subset of the data, and a transmitting circuitry 54 configured to send the subset of the data to the end device 10.

According to another embodiment, the storage node 14 is arranged to receive the data from a network node, the data comprising the identity, before receiving a request for a subset of data. The storage node 14 is further arranged to store the received data in a memory 57 (not illustrated in FIG. 5a)

FIG. 5b is a schematic diagram illustrating some components of the storage node 14.

The components of the storage node 14 that is illustrated in FIG. 5b is a memory 57 and a central processing unit (CPU) 55, capable of executing software instructions stored in the memory 57, wherein the memory 57 can be any combination of read and write memory (RAM) and read only memory (ROM). The memory also comprises persistent storage, which, for example, can be any single one or combination of magnetic memory, optical memory, or solid state memory or even remotely mounted memory.

FIG. 5b also illustrates an I/O interface 56 for communicating with the end device 10 and the network node 12.

The storage node 14 can be any suitable computer capable of performing the tasks as described herein. For example, the first network node 12 can be a computer running an operating system such as Linux, Microsoft Windows, Apple Mac OS X, UNIX variants, etc.

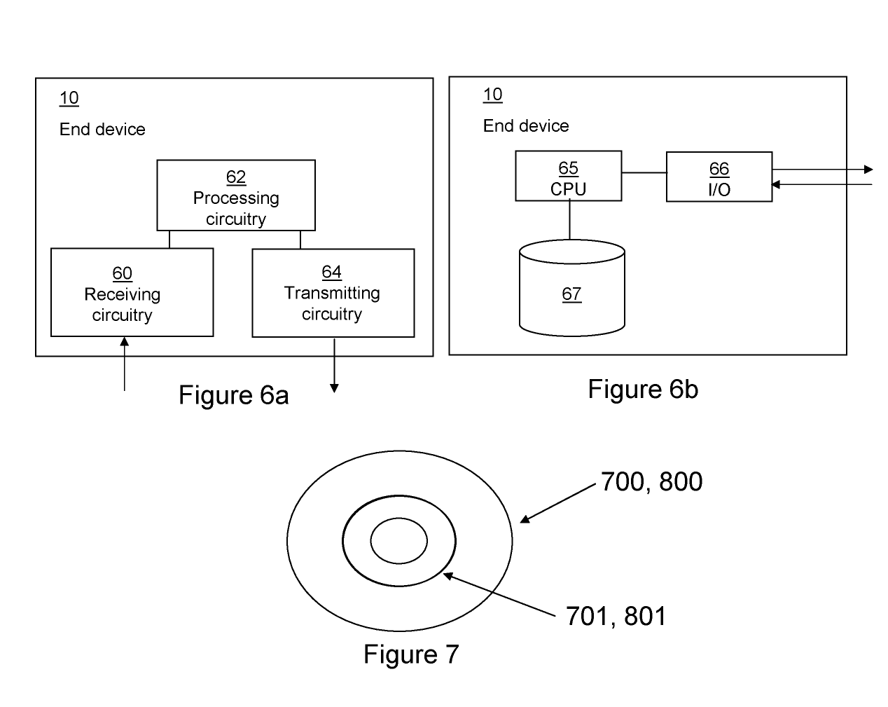

FIG. 6a is a schematic diagram illustrating functional modules of the end device 10. The modules can be implemented using hardware and/or software such as computer program executing in the end device 10. All modules depend on an execution environment which utilizes the components shown in FIG. 6b. The modules correspond to the steps of the method illustrated in FIG. 4.

FIG. 6a shows an end device 10 comprises a processing circuitry 62 and a transmitting circuitry 64 configured to send via a network node 12 to a storage node 14 data relating to activities performed by the end device. The data sent comprises an identity that uniquely identifies the identity module comprised in the end device. The transmitting circuitry 64 is further configured to send a request to the storage node 14 requesting a subset of the data, the request comprises the identity.

FIG. 6a also shows a receiving circuitry 60 configured to receive the subset of the data.

FIG. 6b is a schematic diagram illustrating some components of the end device 10.

The components of the end device that is illustrated in FIG. 6b is a memory 67 and a central processing unit (CPU) 65, capable of executing software instructions stored in the memory 67. The memory 67 can be any combination of read and write memory (RAM) and read only memory (ROM). The memory also comprises persistent storage, which, for example, can be any single one or combination of magnetic memory, optical memory, or solid state memory or even remotely mounted memory.

FIG. 6a also shows an I/O interface 66 for communicating with the network node 12 and the storage node 14.

The end device 10 can be any suitable computer capable of performing the tasks as described herein. For example, the end device 10 can be a computer running an operating system such as Linux, Microsoft Windows, Apple Mac OS X, UNIX variants, etc.

FIG. 7 shows one example of a computer program 700, 800 comprising computer readable means. On this computer readable means a computer program 701, 801 can be store, which computer program can cause a controller to execute a method according to embodiments described herein, e.g. in connection with the FIGS. 3 and 4. In this example, the computer program product is an optical disc, such as a CD (compact disc) or a DVD (digital versatile disc) or a Blu-Ray disc. As explained above, the computer program product could also be embodied as a memory of a device, such as memory 57 of the storage node 14 or memory 67 of the end device 10. While the computer program 701, 801 is here schematically shown as a track on the depicted optical disk, the computer program can be stored in any way which is suitable for the computer program product.

It is an advantage with the embodiments to provide a mechanism for the end user to obtain information related to activities in connection with the usage of the end devices, in a secure way.

However, the above mentioned and described embodiments are only given as examples and should not be limiting to the present invention. Other solutions, uses, and functions within the scope of the invention as claimed in the accompanying patent claims should be apparent for the person skilled in the art.

1. A method in a storage node of a communication network for delivering to an end device, a subset of data, the data being stored in the storage node and related to an identity that uniquely identifies an identity module comprised in the end device, the method comprises:
receiving from the end device a request for the subset of the data, the request comprises the identity;
identifying the data related to the identity;
filtering the identified data to obtain the requested subset of the data; and
sending the subset of the data to the end device.

2. The method according to claim 1 wherein receiving from the end device a request for the subset of the data is preceded by:
receiving the data from a network node, the data comprising the identity; and
storing the data.

3. The method according to claim 1, wherein the identity module is one of a Subscriber Identity Module (SIM), a soft SIM, a Enhanced SIM (E-SIM), a Universal SIM (USIM), or a Machine Card identity Module (MCIM).

4. The method according to claim 1, wherein the identity is one of a Mobile Station International Subscriber Directory Number (MSISDN) or a International Mobile Subscriber Identity (IMSI) of the end device.

5. A method in an end device of a communication network for receiving from a storage node, a subset of data, the data being related to an identity that uniquely identifies an identity module comprised in the end device, the method comprises:
sending via a network node to the storage node the data, the data being related to activities performed by the end device and comprises the identity;
sending a request to the storage node requesting the subset of the data, the request comprises the identity; and
receiving the subset of the data.

6. The method according to claim 5 wherein the identity module is one of a Subscriber Identity Module (SIM), a soft SIM, a Enhanced SIM (E-SIM), a Universal SIM (USIM), or a Machine Card identity Module (MCIM).

7. The method according to claim 5, wherein the identity is one of a Mobile Station International Subscriber Directory Number (MSISDN) or a International Mobile Subscriber Identity (IMSI) of the end device.

8. A storage node connectable to a communication network and arranged to deliver to an end device, a subset of data, the data being stored in the storage node and related to an identity that uniquely identifies an identity module comprised in the end device, the storage node comprising:
a receiving circuitry configured to receive from the end device a request for the subset of the data, the request comprises the identity;
a processor circuitry configured to:
identify the data related to the identity; and
filter the identified data to obtain the requested subset of the data; and
a transmitting circuitry configured to send the subset of the data to the end device.

9. The storage node according to claim 8, wherein the storage node further comprises a memory, and is arranged to:
receive, by the receiving circuitry, the data from a network node, before receiving a request for the subset of the data, the data comprising the identity; and
store the data in the memory.

10. The storage node according to claim 8, wherein the identity module is one of a Subscriber Identity Module (SIM), a soft SIM, a Enhanced SIM (E-SIM), a Universal SIM (USIM), or a Machine Card identity Module (MCIM).

11. The storage node according to claim 8, wherein the identity is one of a Mobile Station International Subscriber Directory Number (MSISDN) or a International Mobile Subscriber Identity (IMSI) of the end device.

12. An end device connectable to a communication network and arranged to receive from a storage node, a subset of data, the data being related to an identity that uniquely identifies an identity module comprised in the end device, the end device comprising:
a transmitting circuitry configured to:
send via a network node to the storage node the data, the data being related to activities performed by the end device and comprises the identity.
send a request to the storage node requesting the subset of the data, the request comprises the identity;
a receiving circuitry configured to receive the subset of the data.

13. The end device according to claim 12 wherein the identity module is one of a Subscriber Identity Module (SIM), a soft SIM, a Enhanced SIM (E-SIM), a Universal SIM (USIM), or a Machine Card identity Module (MCIM).

14. The end device according to claim 11, wherein the identity is one of a Mobile Station International Subscriber Directory Number (MSISDN) or a International Mobile Subscriber Identity (IMSI) of the end device.

15. A computer program comprising computer readable code which, when run on a storage node, causes the storage node to perform a method as claimed in claim 1.

16. A computer program product comprising a computer readable medium and a computer program according to claim 15, wherein the computer program is stored on the computer readable medium.

17. A computer program comprising computer readable code which, when run on an end device, causes the end device to perform a method as claimed in claim 5.

18. A computer program product comprising a computer readable medium and a computer program according to claim 17, wherein the computer program is stored on the computer readable medium.
